(19) United States
(12) Patent Application Publication
(10) Pub. No.: US 2009/0223193 A1
(43) Pub. Date: Sep. 10, 2009

(54) Mower Blades

(76) Inventor: Barry Herbert Funnell, Auckland (NZ)

Correspondence Address: NIXON & VANDERHYE, PC, 901 NORTH GLEBE ROAD, 11TH FLOOR, ARLINGTON, VA, 22203, US

(21) Appl. No.: 12/227,936

(22) PCT Filed: Jun. 6, 2007
(86) PCT No.: PCT/NZ2007/000139

§ 371 Date: Apr. 3, 2009

(30) Foreign Application Priority Data
Jun. 6, 2006 (NZ) 547751

(51) Int. Cl. A01D 34/10

(52) U.S. Cl. 56/17.5

(57) ABSTRACT

A blade for cutting grass; used within a rotary mower. The swivel-mounted blade has a lower facet parallel to the plane of rotation along one edge, and a lifting surface, which meet at the cutting edge at an angle. Wear, particularly on the facet and also the lifting surface maintains the cutting edge during the life of the symmetrical self-sharpening blade. The lifting surface undergoes wear while blowing cut material upwards while suspended in air. The blade is also suited to mulching and agricultural mowers, and may be made in reversible form.

### FIELD

This invention relates to cutting blades and methods of use, to blades for cutting plant material, and in particular the invention relates to mower blades including but not limited to lawnmower blades.

### BACKGROUND

Rotary mowers could be regarded as devices to move blades rapidly across a grassed surface of a lawn or paddock and thereby cut any leaves or stalks of grass that cross their path. A motor (internal combustion or electric) causes the blades, which are pivotably mounted on the ends of arms or on the periphery of a disk, to spin rapidly about a vertical axis while the mower is moved over the grass to be cut. Speeds of perhaps about 200 km/hr are obtained at the cutting surfaces. Rotary mowers typically have blades which in section are like chisel blades in which all faces (front surface, underneath facet and rear surface) are inclined forwards and at an angle to the plane of rotation, sharpened by bevelling on the top surface of the leading edge. The blades often have an upwards scoop at the back edge to create the airflow needed to either propel the cuttings back into the path of the blade repeatedly for mulching within the mower housing, or to blow cuttings into a receiver bin or catcher. The cutting edges are vulnerable to impact with hard objects. As they wear during a typically 30 hour life, the cutting edges of this type of blade tend to assume a rounded edge instead of the initial sharp cutting edge. The cutting edges retreat upward from the initial cutting height. The plane of rotation is substantially the same as the plane of the surface to be cut, and is often horizontal.

Lawn cutting is useful in urban settings, for parklands, sports fields, and for roadsides (berms). A further major application of the invention is in farming, such as for cutting grass, hay and silage as fodder for animals, or for cutting grain-bearing grasses. Advantages, to be described below, of the cutting blades of this invention are also applicable to the practice of farming.

### PRIOR ART

No publications that describes blades having a similar geometry and mounting position to that described in this specification, nor that claims a self-sharpening attribute, are known to the applicant. FIGS. 5a and 5b, with the associated text, describe two conventional blades that might at first sight be considered as similar, and considers the way that they wear during use.

### DEFINITIONS

“Angle of use” is a descriptor for the preferred amount of tilt of the leading side surface (15) relative to the plane of rotation which is the same as the plane of the leading face surface (17) and (when in use) substantially the same as the plane of the surface bearing grass or the like to be cut.

“Mulching mower” refers to a type of mower in which the cut grass is retained within a housing surrounding the rotating blades during which time air turbulence repeatedly presents the grass to the blades so that the grass is eventually finely divided, or mulched, in which form it is returned to the surface from which it was cut. There is no catcher nor is there an output of cut blades of grass.

“Cutting mower” refers to a type of mower in which the cut grass is blown out from the region of the blades by air flow. It may be caught in a catcher or returned to the surface from which it was cut.

### PROBLEM TO BE SOLVED

Grass stems have abrasive qualities owing in part to the cellulose within and to trapped soil and sand, so grass grinds down the leading edge of a mower blade during cutting, causing the blade to rapidly (within perhaps 10-30 hours of use) to become blunt. In particular, the rooted and fixed remnant part of the trimmed grass plant wears away the leading edge and both the underside and the top part of the blade (depending on the steepness of the slope, if any), as the rapidly spinning blade brushes across it. Unintended impacts with stones, earth or kerbing are ignored but also have the effect of making the blade blunt. Once the edge is blunt, the mowing action relies solely on the speed with which the blade strikes the grass, causing ragged tearing of grass blades rather than smooth cutting. This diminishes the aesthetic appearance of the mowed lawn and limits the speed at which the mower can be propelled while still delivering an acceptable result. Further, increased resistance to movement of the blades requires use of more engine power. The standard means of overcoming the problem is to regularly replace mower blades with new or re-sharpened blades, or to work more slowly.

### OBJECT

It is an object of this invention to provide a blade for a rotary cutter such as a mower, which blade has a self re-sharpening and longer life characteristic on account of orientation and shape, or at least to provide the public with a useful choice in this regard.

### STATEMENT OF INVENTION

In a first broad aspect, the invention provides an elongate narrow blade (10) for a rotary cutter of plant material (a mower), wherein the blade includes a first part including connection means (14) having an axis near a first end for connection (such as by a locked bolt) to a rotatable drive shaft having an axis of rotation; the axis being orthogonal to a plane of rotation, and a second part comprising a working area (13) including a leading side surface (17) comprised of a sloping surface formed along the working area of the blade, and a leading face surface (15) parallel to a surface of the blade; the leading side surface (17) and the leading face surface (15) intersecting at a sharp leading edge (19) along an edge portion of the blade terminating at a second end; the blade being capable of being mounted in an orientation so that the working area is maintained at an angle of use such that, when in use, the leading side surface (17) is substantially parallel to the plane of rotation, and the leading face surface (15) is tilted upwards relative to the plane of rotation at the angle of use.

Preferably the side surface (17) is narrower than the face surface (15).

Preferably the or each leading side is bevelled or otherwise formed to lie substantially parallel to the plane of rotation.

Preferably the connecting means (12) includes a pivotal connector having a pivot axis substantially orthogonal to the plane of the leading side.

Preferably the pivotal connector comprises a mounting aperture passing through the blade, adapted for mounting on a bolt (14) when in use.

Preferably the connecting means further includes a mounting disk to which the blade is pivotally connected, which disk in turn is mounted on the drive shaft.

Alternatively the blade is fixed directly on to the drive shaft.

In one variation the (or each) blade and the blade driving means together comprise a single part or assembly, wherein the assembled set of blades includes a shared mounting means capable of being fixed directly onto the drive shaft. (This part may comprise a single stamped piece of metal).

Preferably the blade includes a twisted portion (11), tilted around a substantially central longitudinal axis, between the connection means (14) and the working area (13) so that the leading side surface (17) is substantially parallel to the plane of rotation; the twist being required when the axis of the connection means is coaxial with the drive shaft.

In one option the blade is flat between the connection means (14) and the working area (13) so that the leading side surface (17) is substantially parallel to the plane of rotation if the axis of the pivotal connector means is slanted (at the angle of use) in relation to the axis of the drive shaft, so that the blades are cheaper to make from strip steel; absent a twisted middle section.

Preferably the angle of use relative to the plane of rotation is between about 5 and 35 degrees.

More preferably, the angle of use is between about 15 and 25 degrees for a cutting mower and between about 5 and about 15 degrees for a mulching mower.

In an alternative view of the preferred angle, the preferred blade type is one in which the length of the leading side is about 2.75 times the thickness of the blade; this being based on tests at various angles of use around 20 degrees using a blade made from a 3 or 4 mm thick spring steel strip.

In another related aspect, the leading side surface is provided with a controlled width previously determined with respect to working conditions and materials so that the rate of wear during use on the leading side surface (17) in comparison to the rate of wear on the leading face surface (15) is such that an effective sharpness of the leading edge (19) is maintained during use.

In a second broad aspect the invention provides a symmetrical twin-edged blade in which the working area of the blade is twisted or otherwise formed around a central longitudinal axis so that the leading side surface (17) lies below the plane of the first part, and a second, trailing side surface (18) lies substantially equally above the plane of the first part, the blade hence having two sharp edges which comprise (a) a leading edge (19) sloped at the angle of use, separating a leading face surface (15) and a leading side surface (17), and (b) a trailing edge also including the angle of use separating a trailing face surface (18) and a trailing side surface (16) of the blade; the blade being substantially rotationally symmetrical if rotated through 180° about a longitudinal axis; so that the blade retains essentially the same form if inverted when in use, in order to take advantage of the newly sharpened edge.

Preferably both leading side surfaces are formed so as to lie substantially parallel to the plane of rotation, when in use.

In a related aspect the trailing edge becomes sharpened as a result of collisions with suspended cut material within the housing surrounding the rotating blades; particularly but not solely if the mower is a mulching mower.

Further, the blade retains balance if turned over periodically since attrition of blade material becomes symmetrical and so that the blade may be turned over when the first sharp edge has been worn away.

Preferably the working part of the twisted blade has said leading side surface (17) lying below the plane of the first part, and a trailing side surface (18) lying substantially equally above the plane of the first part (12).

Preferably at least part of the blade has a generally parallelogram cross-section, with an acute angle between surfaces at the leading and trailing edges of the blade.

In a third broad aspect the invention provides a rotary cutter including at least one blade as described previously in this section.

In a first related aspect, the invention provides that the rotary cutter is a mower, and the leading side surface (17) is the lower face of at least part of the blade; the leading side surface defining a principal bearing surface or plane at which the blade will contact and cut stalks of grass when in use, and the leading face surface (15) is tilted at a rising slope (the angle of use) from the sharp edge (19) formed with the leading side surface (17).

In a second related aspect the invention provides a blade also capable of driving particle flow inside a housing surrounding the blades of a mower, wherein the leading face surface has a rising slope at the angle of use relative to the plane of rotation in order to impel air and particles upwardly when in use.

Optionally the mower with which the blade as described above is used is a mulching mower, having the effect, when in use, of finely dividing the cut grass and of returning it to the lawn or other surface.

In a further option the rotary cutter is scaled up to an agriculturally compatible scale so as to be able (for example) to cut grass for silage.

In a fourth broad aspect the invention provides a method for cutting with a sharpened spinning blade (10); wherein the spinning blade has at least one leading side surface (17) and a leading face surface (15) along a working area (13); the side is narrower than the face and the two meet at an acute angle of between 5 and 35 degrees; the method includes the step of rapidly moving the blade in a plane substantially parallel to the leading side surface while cutting, and the method relies on the effect of wear during use for the maintenance of a sharp edge (19) at the acute angle during use.

Preferably the method is used in a process of cutting grass, wherein the blade is rotated with the leading side lowermost, so that the leading side bears against the cut ends of the cut grass, and the leading face does not, and the leading side is worn down by abrasive contact with the cut ends of the grass, at a greater rate than the leading face is worn down by abrasive contact with particles previously impelled upwardly.

Preferably the blade is rotated with the leading side surface lowermost, so that the leading side surface (17) bears against the cut ends of the cut grass, and the leading face surface (15) does not, and the leading side is worn down by abrasive contact with the cut ends of the grass, at a greater rate than the leading face is worn down by abrasive contact with particles previously impelled upwardly; the blade thereby tending to maintain an effective sharpness.

Optionally the method includes the step of demounting the blade, rotating it by 180 degrees about the long axis, and remounting it at infrequent intervals of the order of 30 hours apart, in order to make the wear on the blade more even.

### PREFERRED EMBODIMENT

The description of a preferred form of the invention to be provided herein, with reference to the accompanying drawings, is given purely by way of example and is not to be taken in any way as limiting the scope or extent of the invention. Throughout this specification unless the text requires otherwise, the word “comprise” and variations such as “comprising” or “comprises” will be understood to imply the inclusion of a stated integer or step or group of integers or steps but not the exclusion of any other integer or step or group of integers or steps.

### DRAWINGS

FIG. 1: is a diagram showing a blade according to the invention in top view.

FIG. 2: is a diagram showing the blade of FIG. 1, in cross-section (A-A) through the working area.

FIG. 3: shows the blade of FIG. 1 (in cross-section) when in operation.

FIG. 4: illustrates the effect of abrasion over time on a blade of this invention.

FIG. 5 a and 5 b: illustrate the effect of abrasion over a similar period on prior-art blades.

FIG. 6: shows the effect of continued abrasion over time on one edge of a blade of this invention.

FIG. 7: shows the effect of continued abrasion over time on both edges of a blade of this invention which has been turned over periodically. Sections through the blades along line A-A are shown below.

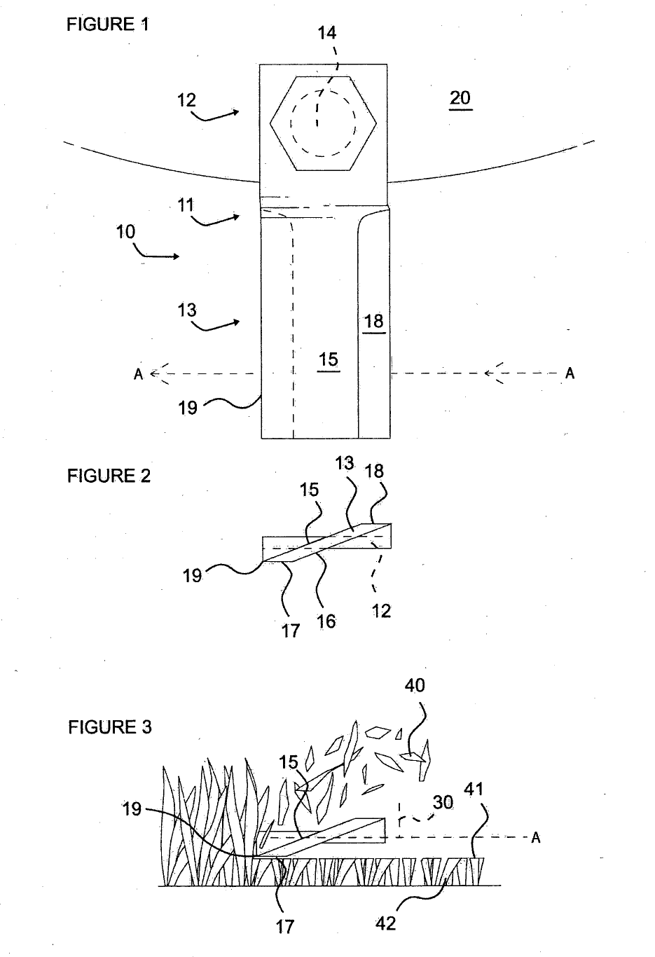

In its preferred form the invention includes a self-sharpening blade for a mower although the skilled reader will be aware that a mower is one application of a number of possible applications both within and outside the cutting of plants in situ. As shown in FIGS. 1 and 2, the blade 10 comprises a generally rectangular strip of metal with generally wide, flat faces defined by the length and width of the strip, and generally narrow sides defined by the length and thickness of the strip. Conveniently, the blade 10 has a twist partway along its length (11), so that a connector part 12 of the blade lies substantially parallel to the plane of rotation A of the mower, while a cutting part 13 is tilted by the twist out of the plane of rotation A. That tilt (the angle of use) sets the cutting angle. (The term “twist” implies a process of deforming a metal plate or strip. That does not preclude other ways of fashioning a blade of the shapes to be described, such as casting, or milling from the solid).

The connector part 12 comprises a mounting by which the blade can be bolted to a generally flat circular mounting plate 20, forming a usually existing part of a cutting machine, which in turn is mounted on the drive shaft 30. As is known in the art, the mounting is preferably provided as a single bolt hole 14 at one end of the blade, so that the blade can swivel on the bolt (which is locked and cannot be unscrewed) if it hits a solid obstruction, to protect the blade and the cutting machine and also to limit damage to the obstruction. It should be noted that one more economical way to use blades according to the invention is to provide a blade mounting disk for non-twisted (and therefore cheaper) blades, in which the mounting disk itself is provided with slanted holes (at the angle of use) for receiving lockable mounting bolts. The blade mounting disk with slanted holes may be a component of certain types of mower and may be made of pressed steel for example. Twisted blades can be used with existing mowers and mounting disks.

The cutting part 13 provides the cutting edge or edges of the blade 10, and also creates an updraft, like a fan, by which the cut blades of grass can either be lofted into a catcher, or circulated for further cutting and eventual mulching. This part of the blade has an upper leading face 15 and a lower trailing face 16, both of which lie at the angle of use to the plane of rotation A. The sides of the outer part 13 are bevelled, to provide a lower leading side 17 and an upper trailing side 18, both substantially parallel to the plane of rotation A.

The inventor has established that the angle of use, for a mulching mower is about 5 to 15 degrees; preferably ten degrees for a mulching mower, and about 15 to 35 degrees; more preferably 20 degrees, for other types of mower. The acute angle between the leading face 15 and leading side 17 provides a sharp leading edge 19, which is the cutting edge of the blade in use. Prior-art blades, (as in FIG. 5a or 5b) are discussed below.

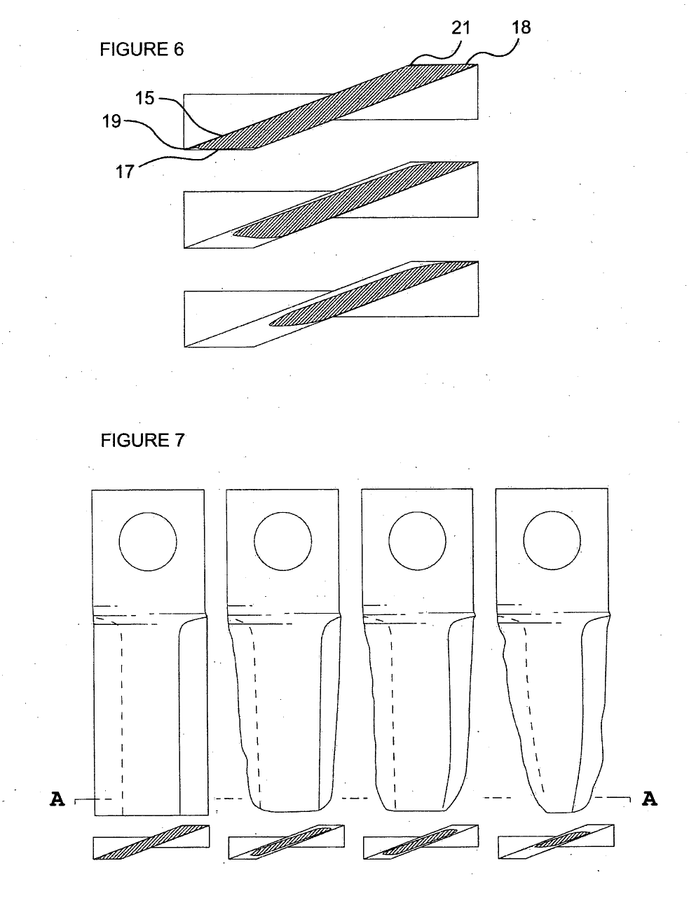

In mulching use, as shown in FIG. 3, the tilted leading face 15 drives and deflects the fragments of grass 40 cut by the leading edge 19 upwardly into the blade housing (together with blown air), such that the fragments fall back through the blades to be repeatedly cut. This process reduces (mulches) the cut fragments to a small enough particle size to fall into the remaining ground cover and largely disappear from sight, giving a pleasing finish to the lawn with no need for catching and disposal of grass. As shown in more detail in FIGS. 6 and 7, this function causes some wear on the tilted leading face 15, but the wear is spread across the whole width of that face and gradually wears the whole blade thinner with slightly stronger wear towards the top corner 21, away from the leading edge 19. The cut ends 41 of the trimmed grass plants 42 under the blade, which abrade more strongly than the loose fragments of grass 40 above, contact and abrade only the relatively narrow leading side 17.

The inventor provides the following theory of operation along with the usual cautions since properly controlled trials under a variety of conditions have not yet been made, despite intensive use. Blades according to the invention are believed to acquire a self-sharpening property as follows:

1. The blade is made with a facet or face (leading side 17) along one side of a cutting edge.
2. The blade is mounted so that the facet is in the plane of rotation.
3. In a cross-section, the facet width at the angle of use is 1/tan(preferred angle) which is about 2.75 times the thickness of the blade for a 20 degrees example, based on tests with a 3 or a 4 mm thick steel strip blade. The facet width is a function of the angle. It may be that other blade thicknesses than 4 mm will correspond to a preferred angle other than the currently preferred 20 degrees although that angle is also suitable for the fanning/deflection effect.

In a mulching mower, the trailing sharp edge is subjected to some abrasion and is sharpened or re-sharpened despite moving in a trailing-edge sense, as a result of considerable turbulence within the housing.

The inventor believes that either preferred angle of use, obtained by trial and error, dictates that the facet surface length is not so long that the sharpening effect of friction against grass stems and the like cannot keep up with removal of blade material from the actual cutting edge itself, which would otherwise have a rounding and bluntening effect on the edge. The best angle may be found to depend on the rate of abrasion of a particular kind of metal and a particular abrasiveness of the material being cut (see below). The preferred angle also affects the upwards blowing or fanning effect of the blade. Some sources of wear on the blade are:

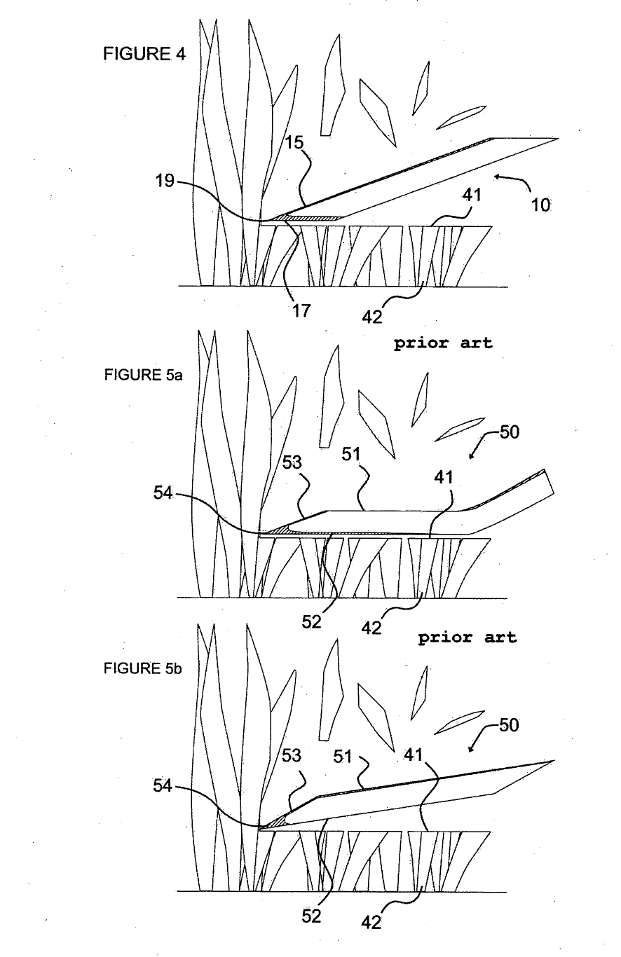

1. (for all types of mower) Leading side (17): abrasion from rubbing contact with fixed objects such as (a) cut stumps of grass including cellulose and lignin, (b) soil, some of which becomes mixed with the plant material, (c) stones on the ground or (d) concrete edgings, which will tend to remove material over the leading side 17, the lowest surface. After a stem of grass is cut, the cutter passes over the cut end of the base many times—perhaps 30-50—on account of the relatively slow forward speed of a mower as compared to the rotational speed. Grass is fibrous and does cause wear on metal surfaces, and with the blade rotating at speeds of typically 3500 rpm, (which is a cutting speed of about 90 metres/second) the cut ends 41 wear down not only the cutting edge 19 but also the lower surface of the blade as it brushes continually across the cut ends in use. As shown in FIG. 4, for a blade of this invention the lower surface of the blade is the leading side 17. (The velocity (tip speed) may be calculated from the rotation rate and the mean circumference of the circle swept by any one working surface)
2. (more particularly for mulching mowers): Leading face (15): abrasion (see below) from airborne (a) cut grass, (b) soil, or (c) stones which will tend to remove material from the leading face 15 of the cutting edge. This blade is suitable for use within a mulching mower in which there is a high proportion of airborne material within the casing of the mower that repeatedly impacts the leading face.
3. (all mowers) Leading (cutting) edge (19) wear: both of the above types of abrasion will apply, and also unintended collisions with hard objects will cause the blade material to crack, spall or break off. It is perhaps surprising that the (1) and (2) wear rates keep up with or exceed the (3) wear rate when blades of the present invention are in use according to the method given, but not when prior-art blades are in use, when the leading edge becomes rounded and hence far less effective even in the absence of accidental impacts. It is likely that the side 17, having a controlled (and constant) width of bearing surface, wears down at substantially the same rate as the leading edge 19; hence renewing the edge 19, thereby keeping the blade relatively sharp. Meanwhile the overall blade shape is maintained (within limits) despite wear.
4. Trailing side: Especially when used in a mulching mower there is abrasion of the uppermost surface, the trailing side 18. This is effective over time in increasing the sharpness of the un-used trailing cutting edge. As a result of turbulence, collisions between suspended or flying fragments of grass suspended in turbulent air within the casing of the mulching mower and the surface 15 (see FIG. 4) is responsible for removal of material from the top side 15 and face 18 of the cutting edge. The trailing cutting edge further cuts or otherwise disintegrates grass that is suspended within the housing around the rotating blades while itself becoming at least partially sharpened. When the preferred symmetrical blades are in use, infrequent (ca. 30 hours) rotation of each blade on its mount increases the overall effectiveness of this type of blade. If precision during grass cutting is required, the entire mower can be adjusted in height from time to time by normal means to take up that wear which otherwise would have the effect of gradually raising the cutting height by a few millimetres.
5. For completeness note that impacts or collisions against stones in the ground or concrete edgings may dull even blades according to the invention by deforming the cut edge or by breaking off parts of the edge. These are regarded as accidents rather than normal wear. In time, these blunt parts will become re-sharpened. Such damage is visible in FIGS. 7B, 7C and 7D as a progressive narrowing of the width of the leading face.

A proposed theory might be supported by observing the site of wear of a new blade according to the invention. FIGS. 6A, 6B and 6C show wear in a blade which has not been regularly turned over, as recommended, after every 50-100 hours of use. (FIGS. 7A, to 7D show wear in a blade which has been turned over.) FIG. 6 and FIG. 7 show examples of progressively worn blades of this invention, used in one and two orientations respectively. As shown, the blade wears in such a way that over time the profile of the blade reduces in size as it wears, but maintains the same general shape with a relatively sharp cutting edge 19. The width of the blade is greater than the thickness, but the leading side wears more quickly than the leading face, with the result that the proportions of the blade profile stay approximately the same as it wears. Even if the cutting edge is damaged by impacts with stones or the like, the damage is gradually ground out by the relatively heavy wear on the lower leading side 17 and the lighter wear on the leading face 15, to eventually form a new sharp edge with the same or a similar bevel to a new blade. The cross-sections reflect the wear.

Regardless of conjecture, the shape of the blades of the invention as described here do exhibit a self-sharpening effect during regular commercial use when mounted in the orientation described, as observed by the inventor (who has a franchised lawn mowing service) and his colleagues.

In contrast, a first form of conventional blade 50 as shown in FIG. 5a has faces 51 and 52 running substantially parallel to the plane of rotation, with the lower surface of the blade being the face 52, and the bevelled side 53 of the blade above. The face 52 provides a wide bearing surface against which the cut ends 41 brush, so that the rate of wear on the face is significantly slower than the rate of wear on the leading edge 54. The leading edge 54 is accordingly blunted. A second form of conventional blade 50 as shown in FIG. 5b looks superficially similar to the blade of this invention, with the blade being tilted at an angle to the plane of rotation, but with the bevelled side 53 uppermost. With such a blade, the lower face 52 is effectively protected from any wear, and all wear caused by the cut ends 41 of the grass occurs only on the leading edge 54, rapidly blunting it. Possible development of a leading face on this blade is prevented by the continuously changing geometry, at least because the leading face changes in width with wear.

It is possible that an effective blade might be made having a tilt angle (the angle of use) outside the preferred range (5 to 35 degrees), but modified by addition or removal of material towards the trailing side of the leading side so that the facet width (as referred to a cross-section) is about the same as for a 20 degrees angle, which is the most preferred angle. That option would not retain the substantially constant facet width on the leading face (17).

Particularly within a mulching mower, the impact of the cut fragments of grass 40 on the blade will gradually wear the bevelled leading side 53 along with the upper face 51, and this wear will tend to sharpen the leading edge 54 somewhat. However the rate of wear from the cut fragments is less than the rate caused by the cut ends 41 under the blade, and accordingly the blade will be blunted faster than it is sharpened. Furthermore the wear caused by impact with the cut fragments 40 is dispersed across the upper face 51 as well as the leading side 53, reducing any sharpening benefit. Consequently the leading edge 54 becomes blunted in use.

Attributes of the symmetrical dual-edge blade, with its axis of symmetry along the radius of rotation include that if the leading edge 19 is damaged or eventually becomes blunted, or if the recommended time for rotation elapses, the blade 10 can be unbolted and flipped over, then remounted so that the other bevelled side 18 becomes the lower and leading side, providing a new cutting edge. Also, loss of balance owning to wear at one edge can be remediated by applying the wear to the other edge. Wear at the top corner 21 reduces the width of the trailing side 18, but does not impact the sharp edge, so the reversed blade presents essentially unused leading surfaces. As shown in FIG. 7, the blade can become considerably worn in both orientations and still present a sharp, functional cutting edge, albeit somewhat smaller and more curved than a new blade. The inventor prefers to discard these blades after about 300 hours of use, when they become so thin (about 2 mm) that they might be bent by inadvertent impacts.

In the preferred embodiment illustrated in FIGS. 1 to 4, 6 and 7 the blade is made from a strip of spring steel with a hardness of RC43, and is approximately 100 mm long, 35 mm wide and 4 mm thick. The bolt hole 14 is approximately 10 mm in diameter. In this configuration, the outer 60 mm of the blade is tilted at 20° (or another angle of use) relative to the first part, with the radius of rotation as pivot point. Different mowing machines will be best used with specific blade lengths. The inventor considers that the angle of tilt is relatively important. Note that a 20 degrees twist is at this point a preferred angle for mulching, though 10 degrees is preferred for cutting, while a range of angles from about 5 to about 35 degrees are usable. (Of course, use of a mounting disk with slanted holes would allow use of non-twisted blades).

### Trial 1.

Two blades according to the invention were mounted on each of two rotors in a mulching mower and used for 100 hours. The blades were then measured. The correlation between rotor and blade was lost but it appears by looking at the outlines that B and C were one pair, and A and D were the other pair. Paint thickness was about 0.15 mm. Measurements made by vernier micrometer are shown in Table 1.

TABLE 1

| Blades @ 100 hrs use | A | B | C | D | Mean |
|---|---|---|---|---|---|
| Original thickness | 3.430 | 3.410 | 3.340 | 3.380 | 3.390 |
| Original width | 35.000 | 35.000 | 35.000 | 35.000 | 35.000 |
| Trailing thickness | 3.140 | 3.140 | 3.200 | 3.250 | 3.183 |
| Leading thickness | 3.150 | 3.140 | 3.200 | 3.200 | 3.173 |
| Centre thickness | 3.200 | 3.180 | 3.240 | 3.280 | 3.225 |
| Width | 32.200 | 31.600 | 32.450 | 32.600 | 32.213 |
| Removed material: | | | | | |
| Trailing thickness | 0.290 | 0.270 | 0.140 | 0.130 | 0.208 |
| Leading thickness | 0.280 | 0.270 | 0.140 | 0.180 | 0.218 |
| Centre thickness | 0.230 | 0.230 | 0.100 | 0.100 | 0.165 |
| Width | 2.800 | 3.400 | 2.550 | 2.400 | 2.788 |

All blades showed smooth wear over the entire leading face although stone pits could be discerned. The trailing face was unworn, so a central mound of about 0.045 mm is shown at the “centre thickness” line. The wear over the leading face was relatively even. Only blade A showed full-width abrasion of the trailing face so that the trailing edge of A was beginning to become sharper at the time of measurement. Blade C showed almost as much wear. Blades B and D showed wear on just the leading half of the trailing face. In the case of blade D this wear was causing significant rounding of the original flat face of the trailing edge, which may suggest that it was not mounted at the correct angle. All blades showed rough wear of the leading face, the one facing the ground, as if made by a very coarse grinding wheel. This was a distinctly different kind of wear to that on the leading surface. Presumably much of this wear was caused by hitting stones embedded in the surface being cut, and accidentally hitting kerbing. These faces now had an incline of about 3 degrees upward towards the cutting surface, and rolled upward toward the free end, suggesting (unsurprisingly) greater wear at the free end.

### Variations

While the embodiment described above is currently preferred, it will be appreciated that a wide variety of variations might be made within the general spirit and scope of the invention.

Although the blades including twists are designed for mounting upon existing mowers or the like having bolts coaxial with the drive shaft, an untwisted blade that is otherwise according to the invention may be used on a drive shaft terminating in a plurality of slanted mounting means so that the untwisted blade is held at an angle.

In particular, the blade might be made with only a single bevelled side, and only one sharp edge. Such a blade could not be flipped over and reused in the manner described above, but could still provide some of the advantageous features of this invention, such as having a self-sharpening attribute.

The blade might be made without a twist between the connector portion and the cutting portion, if the mounting plate 20 was provided with angled flanges or seats onto which the blade is attached, so that the straight mounted blade is tilted “as bolted” to the appropriate angle relative to the plane of rotation.

Any blade that has a cutting end (working area) conforming to the invention as described and illustrated herein is included as an embodiment, even though the blade may include more elaborate mounting means and may for example be an assembly of blades including more than one cutting end sharing a common support in such as a “T” or “X” or “*” overall shape rotated about its centre.

The blade can be double-ended and extend the full diameter of the cutting circle, with means to be attached directly to the drive shaft, whether with an integral central disk 20, or as a simple elongate blade.

The dimensions of the blade can be varied to suit different mowers and applications.

The angle at which the blade is set and the angle of the bevel can be varied, as long as the net result keeps the bevelled side more or less parallel to the plane or rotation. The optimum angle is believed to be around 20°, or preferably between 15° and 25°, but variations of 15° to either side may yield workable results. The more acute the angle is, the sharper the cutting edge will be, but the bevelled leading side will be correspondingly wider, and the updraft the blade can create will also be correspondingly less.

The blade can be made from different materials, or a combination of materials, as long as the leading side and cutting edge is of sufficient hardness.

The blade can be adapted for other cutting applications, e.g. hedge cutters and trimmers, and cutters for grass and other plants used for grains or fodder.

### Advantages

Advantages of the preferred blade include:

Speedy and efficient mowing is maintained while or because the blades stay, sharp during a much longer life (100-300 hours) than prior-art blades (30 hours). Blades of the present invention tend to stay sharp until their material has almost disappeared.

Mulching-type mowing of lawns is facilitated since the or each trailing edge contributes to the mulching or pulversising of the cut grass while itself becoming sharpened.

Lawn or paddock mowing is more ecologically sustainable since less energy is used to cut grass than when prior-art blades are used. Most users would keep on using blunt blades until their mass has been broken off such as by collision. A smaller engine or motor can be used on a purpose-built lawnmower, and/or a given area can be cut more quickly.

Dual blades, which can be used either way up, are more economical than one-way blades.

The same advantages apply when the blades are used in agricultural applications such as for cutting silage from a paddock or when macerating a grass crop after removing it from the paddock.

Finally, it will be understood that the scope of this invention as described by way of example and/or illustrated herein is not limited to the specified embodiments. Those of skill will appreciate that various modifications, additions, known equivalents, and substitutions are possible without departing from the scope of the invention as set forth in the following claims.

1-18. (canceled)

19. An elongate blade for a rotary cutter for cutting plant material, including:
i. a first part comprising connection means for connection to a rotatable drive shaft of the rotary cutter; and
ii. a second part comprising leading face and side surfaces intersecting at a leading edge, and trailing face and side surfaces intersecting at a trailing edge;
where the leading side surface and the trailing side surface are substantially parallel to the plane of rotation, and the leading face surface and trailing face surface are at an angle relative to the plane of rotation.

20. The elongate blade as claimed in claim 19 where the width of the side surfaces is narrower than the width of the face surfaces.

21. The elongate blade as claimed in claim 20 where the blade has 2-fold rotational symmetry about its longitudinal axis.

22. The elongate blade as claimed in claim 21 where the angle is between about 5 and 15 degrees.

23. The elongate blade as claimed in claim 21 where the angle is between about 15 and 25 degrees.

24. A rotary cutter where the rotary cutter includes a blade as claimed in claim 19.

25. The rotary cutter as claimed in claim 24 where the rotary cutter is a mower and includes at least one blade in which the leading face surface and trailing face surface are at an angle relative to the plane of rotation of between about 5 and 15 degrees.

26. The rotary cutter as claimed in claim 24 where the rotary cutter is a mower and mulcher and includes at least one blade the leading face surface and trailing face surface are at an angle relative to the plane of rotation of between about 5 and 25 degrees.
